(19) United States
(12) Patent Application Publication
(10) Pub. No.: US 2016/0247260 A1
(43) Pub. Date: Aug. 25, 2016

(54) IMAGE PROCESSING APPARATUS, IMAGE PROCESSING SYSTEM, AND IMAGE PROCESSING METHOD

(71) Applicants: Satoshi Nakamura, Kanagawa (JP); Toshifumi Yamaai, Kanagawa (JP)

(72) Inventors: Satoshi Nakamura, Kanagawa (JP); Toshifumi Yamaai, Kanagawa (JP)

(73) Assignee: RICOH COMPANY, LTD., Tokyo (JP)

(21) Appl. No.: 14/986,833

(22) Filed: Jan. 4, 2016

(30) Foreign Application Priority Data
Feb. 20, 2015 (JP) 2015-031239

(51) Int. Cl. G06T 3/40; G06K 9/62

(52) U.S. Cl. CPC G06T 3/4076; G06K 9/6202; G06K 9/6265

(57) ABSTRACT

An image processing apparatus performs image processing on a first image. The image processing apparatus includes a first storage unit configured to store a first entry indicating an image before changing and the image after changing; a selecting unit configured to select a second entry from the first entry, based on a feature amount vector indicating a feature amount by a vector, the feature amount indicating a distribution of pixel values indicated by pixels included in the first image; a second storage unit configured to store intermediate data identifying the second entry; and a generating unit configured to generate a second image by performing the image processing on the first image, based on the intermediate data.

### BACKGROUND OF THE INVENTION

1. Field of the Invention

The present invention relates to an image processing apparatus, an image processing system, and an image processing method.

2. Description of the Related Art

Conventionally, there are cases where the quality of image data is reduced by resolution conversion, or JPEG (Joint Photographic Experts Group) compression, etc. Accordingly, there are known processes that are performed on the image that has become low-quality; examples are a super-resolution process of supplementing the edges or the texture of an image with high frequency components, a sharpening process of emphasizing the edges of an image, etc.

An example of a super-resolution process is a method referred to as a learning-type super-resolution process. The learning-type super-resolution process includes a learning process and a super-resolution process. First, in the learning process, the process of how the image deteriorates is learned by using multiple training data items that are prepared in advance, and dictionary data is generated, which stores pairs of patterns constituted by a pattern before deterioration and a pattern after deterioration. Meanwhile, in the super-resolution process, the low-quality image is supplemented with high-frequency components based on the dictionary data stored in the learning process, to improve the sense of resolution of the image.

In the learning process, small areas corresponding to each other are respectively cut out from the training data and from a low-resolution image obtained by reducing the resolution of the training data, and the cut-out areas are paired together. A plurality of pairs of small areas are registered to generate dictionary data. Furthermore, in the super-resolution process, the dictionary data generated in the learning process is used to supplement an input image with high frequency components (see Patent Document 1).

However, in the conventional super-resolution process, in order to restore the image by high frequency components with high precision, there are cases where many pairs are used for the process of supplementing the image with high frequency components. In this case, as many pairs are used, the processing load relevant to the pairs is increased, and therefore the processing load relevant to the super-resolution process may increase.

Patent Document 1: Japanese Patent No. 4140690

### SUMMARY OF THE INVENTION

The present invention provides an image processing apparatus, an image processing system, and an image processing method, in which one or more of the above-described disadvantages are eliminated.

According to an aspect of the present invention, there is provided an image processing apparatus for performing image processing on a first image, the image processing apparatus including a first storage unit configured to store a first entry indicating an image before changing and the image after changing; a selecting unit configured to select a second entry from the first entry, based on a feature amount vector indicating a feature amount by a vector, the feature amount indicating a distribution of pixel values indicated by pixels included in the first image; a second storage unit configured to store intermediate data identifying the second entry; and a generating unit configured to generate a second image by performing the image processing on the first image, based on the intermediate data

According to an aspect of the present invention, there is provided an image processing system including one or more image processing apparatuses for performing image processing on a first image, the image processing system including a first storage unit configured to store a first entry indicating an image before changing and the image after changing; a selecting unit configured to select a second entry from the first entry, based on a feature amount vector indicating a feature amount by a vector, the feature amount indicating a distribution of pixel values indicated by pixels included in the first image; a second storage unit configured to store intermediate data identifying the second entry; and a generating unit configured to generate a second image by performing the image processing on the first image, based on the intermediate data.

According to an aspect of the present invention, there is provided an image processing method performed by an image processing apparatus for performing image processing on a first image, the image processing method including storing a first entry indicating an image before changing and the image after changing; selecting a second entry from the first entry, based on a feature amount vector indicating a feature amount by a vector, the feature amount indicating a distribution of pixel values indicated by pixels included in the first image; storing intermediate data identifying the second entry; and generating a second image by performing the image processing on the first image, based on the intermediate data.

### BRIEF DESCRIPTION OF THE DRAWINGS

Other objects, features and advantages of the present invention will become more apparent from the following detailed description when read in conjunction with the accompanying drawings, in which:

FIG. 1 illustrates a usage example of an image processing apparatus according to an embodiment of the present invention;

FIG. 2 is a block diagram of an example of a hardware configuration of the image processing apparatus according to an embodiment of the present invention;

FIG. 3 is a flowchart of an example of the overall process performed by the image processing apparatus according to a first embodiment of the present invention;

FIG. 4 illustrates an example of an entry according to an embodiment of the present invention;

FIGS. 5A through 5C illustrate an example of a process relevant to the feature amount vector performed by the image processing apparatus according to an embodiment of the present invention;

FIGS. 6A through 6C illustrate another example of a process relevant to the feature amount vector performed by the image processing apparatus according to an embodiment of the present invention;

FIG. 7 illustrates an example of a preview image output by the image processing apparatus according to an embodiment of the present invention;

FIGS. 8A through 8C illustrate an example of a process result of the overall process by the image processing apparatus according to an embodiment of the present invention;

FIG. 9 illustrates an example of a preview image according to a third embodiment of the present invention;

FIGS. 10A through 10C illustrate an example of a process relevant to the feature amount vector performed by the image processing apparatus according to a fourth embodiment of the present invention;

FIG. 11 illustrates an example of a screen displaying preview images, etc., by the image processing apparatus according to an embodiment of the present invention; and

FIG. 12 is a functional block diagram of an example of an image processing apparatus according to an embodiment of the present invention.

### DETAILED DESCRIPTION OF THE PREFERRED EMBODIMENTS

A description is given, with reference to the accompanying drawings, of embodiments of the present invention.

### First Embodiment

### (Usage Example)

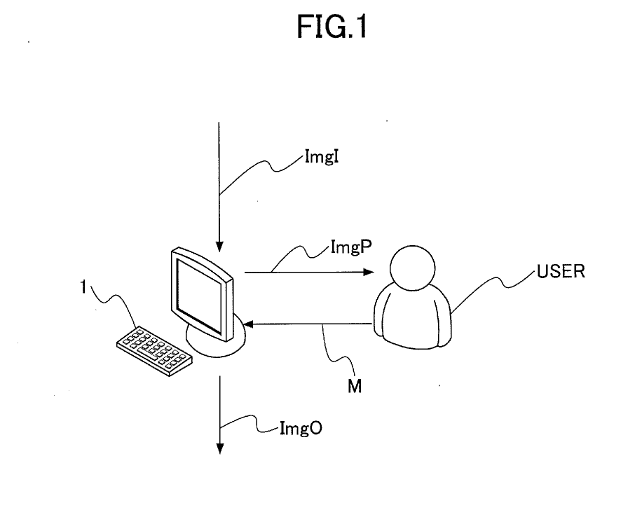

FIG. 1 illustrates a usage example of an image processing apparatus according to an embodiment of the present invention. Specifically, in the following, as illustrated in FIG. 1, a description is given of an example where the image processing apparatus is a PC (Personal Computer) 1 and a USER uses the PC 1. For example, in the PC 1, an input image ImgI is input. Next, the PC 1 performs a super-resolution process, etc., on the input image ImgI that is input, to generate a plurality of preview images ImgP. Furthermore, the generated plurality of preview images ImgP are displayed to the USER.

Furthermore, the USER evaluates the preview images ImgP displayed by the PC 1, and selects one preview image ImgP among the generated plurality of preview images ImgP. That is, the USER inputs an operation M of selecting a preview image ImgP, in the PC 1.

Next, when the USER inputs the operation M, the PC 1 outputs the selected preview image ImgP, as an output image ImgO.

### (Hardware Configuration Example)

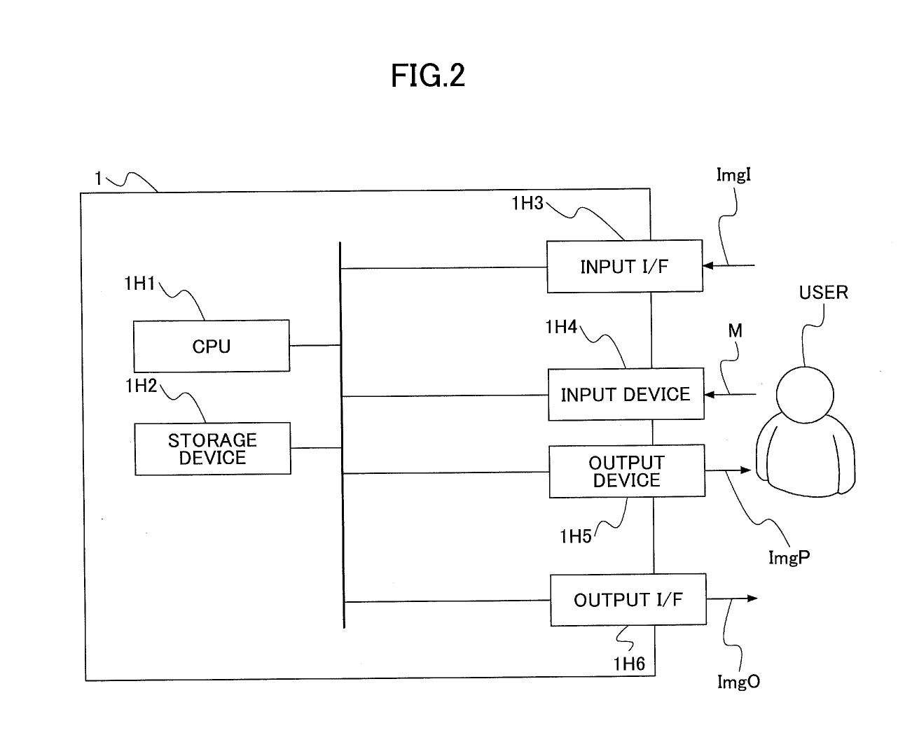

FIG. 2 is a block diagram of an example of a hardware configuration of the image processing apparatus according to an embodiment of the present invention. Specifically, the PC 1 includes a CPU (Central Processing Unit) 1H1, a storage device 1H2, an input I/F (interface) 1H3, an input device 1H4, an output device 1H5, and an output I/F 1H6.

The CPU 1H1 is a arithmetic device for performing various processes executed by the PC 1 and processing various kinds of data such as image data, and a control device for controlling hardware elements, etc., included in the PC 1.

The storage device 1H2 stores data, programs, setting values, etc., used by the PC 1. Furthermore, the storage device 1H2 is a so-called memory, etc. Note that the storage device 1H2 may further include a secondary storage device such as a hard disk, etc.

The input I/F 1H3 is an interface for inputting various kinds of data such as image data indicating the input image ImgI, in the PC 1. Specifically, the input I/F 1H3 is a connector and a processing IC (Integrated circuit), etc. For example, the input I/F 1H3 connects a recording medium or a network, etc., to the PC 1, and inputs various kinds of data in the PC 1 via the recording medium or the network. Furthermore, the input I/F 1H3 may connect a device such as a scanner or a camera to the PC 1, and input various kinds of data from the device.

The input device 1H4 inputs an operation M by the USER. Specifically, the input device 1H4 is, for example, a keyboard, a mouse, etc.

The output device 1H5 displays a preview image ImgP, etc. for the USER. Specifically, the output device 1H5 is, for example, a display, etc.

The output I/F 1H6 is an interface for outputting various kinds of data such as image data indicating the output image ImgO, etc., from the PC 1. Specifically, the output I/F 1H6 is a connector and a processing IC, etc. For example, the output I/F 1H6 connects a recording medium or a network, etc., to the PC 1, and outputs various kinds of data from the

PC 1 via the recording medium or the network.

Note that the hardware configuration may include, for example, a touch panel display, etc., in which the input device 1H4 and the output device 1H5 are integrated in a single body. Furthermore, the PC 1 may be an information processing apparatus such as a server, a smartphone, a tablet, a mobile PC, etc.

### (Overall Process Example)

The PC performs a super-resolution process on an input image that is input. Note that as the super-resolution process, there is a case of processing a single image by using a plurality of images, and a case of processing only a single image. First, in the case of processing a single image by using a plurality of images, for example, the image is a video, and a video includes a plurality of frames, and therefore in the super-resolution process, images indicated by the respective frames are used.

Meanwhile, in the case of processing only a single image, the super-resolution process is a so-called learning-type super-resolution process, etc. For example, in the learning-type super-resolution process, data indicating an image before the image is changed and data indicating the image after the image has been changed are paired together, and the data obtained by the pairing operation (hereinafter, “entry”) is stored in the PC in advance. Furthermore, in the learning process in the learning-type super-resolution process, a pair of images (hereinafter, “image patches”) is used. Specifically, the pair of image patches is obtained by cutting out certain areas that correspond to each other, from a high-resolution image, and a low-resolution image obtained by reducing the resolution of the high-resolution image. The cut-out areas are paired together to obtain a pair of image patches. The image patches are resolved into a basic structural element referred to as a base, and data of a dictionary is constructed by pairing together a high-resolution base and a low-resolution base. Furthermore, in the super-resolution process in the learning-type super-resolution, when restoring a certain area in the input image, the area that is the target of restoration is expressed by a linear sum of a plurality of low-resolution bases, and corresponding high-resolution bases are combined by the same coefficient and are superposed in the target area.

Next, the PC performs a process of restoring high-frequency components based on entries, etc., to generate an image. In the following, a description is given of an example of image processing by using entries.

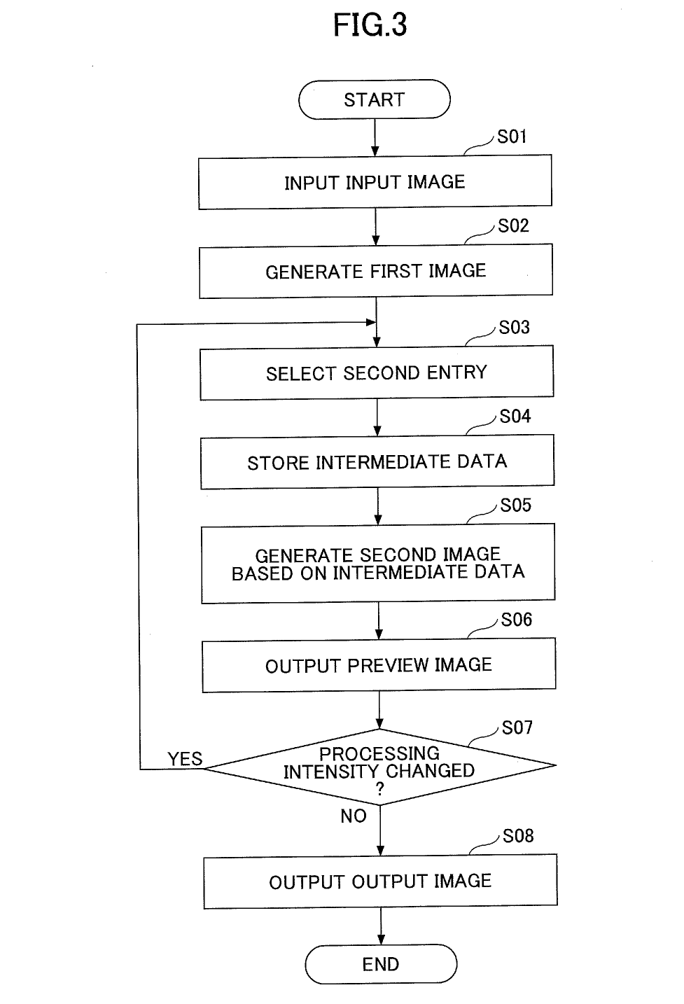

FIG. 3 is a flowchart of an example of the overall process performed by the image processing apparatus according to the first embodiment of the present invention.

### (Example of Inputting Input Image (Step S01))

In step S01, the PC inputs an input image.

### (Example of Generating First Image (Step S02))

In step S02, the PC generates an image (hereinafter, “first image”), from the input image input in step S01. Specifically, in step S02, the PC magnifies or blurs the input image input in step S01, and generates the first image, which is a so-called low-quality image. Note that the PC may set the input image as the first image. For example, there are cases where the user wants to apply a sense of resolution or sharpness to the input image, or where the input image satisfies a predetermined resolution or frequency property.

### (Example of Selecting Second Entry (Step S03))

In step S03, the PC selects an entry to be used. Specifically, in step S03, for example, the PC causes the user to input an operation of instructing the intensity of the high frequency component to be restored by image processing (hereinafter, “processing intensity”), and selects an entry to be used based on the input processing intensity. Furthermore, in step S03, the PC selects an entry by using intermediate data, when the intermediate data described below is stored. Note that as the processing intensity, a predetermined value may be input in the PC in advance, and an initial value may be set.

Furthermore, the processing intensity and the number of entries to be used correspond to each other. For example, the processing intensity and the number of entries to be used are proportionate with each other, and the higher the processing intensity, the more the number of entries to be used.

Furthermore, the relationship between the processing intensity and the number of entries to be used may be defined by a LUT (Look Up Table), etc.

In the following, a description is given of an example in which as the number of entries to be used increases, the high frequency components that are restored by image processing increase.

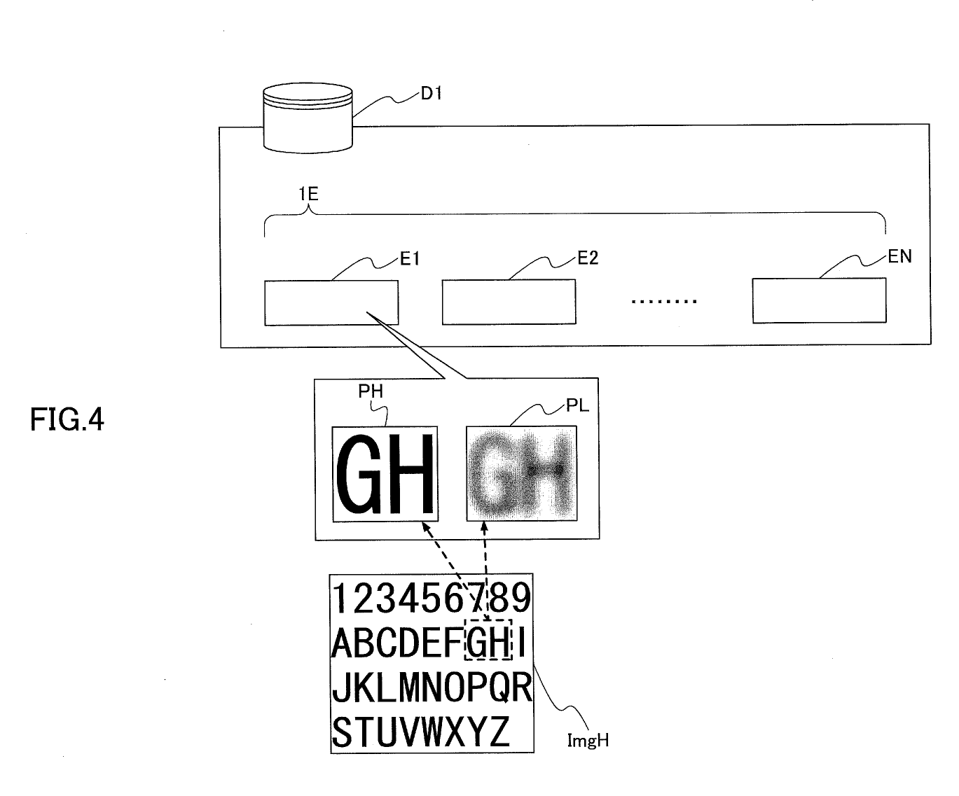

FIG. 4 illustrates an example of an entry according to an embodiment of the present invention. Specifically, an entry is stored as dictionary data D1 in a PC in advance. That is, the dictionary data D1 stores an entry 1E (hereinafter, “first entry”). For example, FIG. 4 illustrates an example where the first entry 1E is constituted by an N number of entries of an entry E1 through an entry EN.

An entry is, for example, stored data in which a low-resolution image and a high-resolution image are paired together. Furthermore, assuming that a high-resolution image ImgH is an image used for learning, an entry is generated from the high-resolution image ImgH. Specifically, an entry includes an image patch having a high resolution (hereinafter, high-resolution patch) PH obtained from the high-resolution image ImgH.

Furthermore, an entry stores an image patch having a low resolution (hereinafter, low-resolution patch) PL based on the high-resolution image ImgH, which is paired together with the high-resolution patch PH. For example, the low-resolution patch PL is generated by blurring the high-resolution image ImgH by a Gaussian filter, etc. That is, an entry is, for example, data storing a high-resolution patch PH as the image before changing and a low-resolution patch PL as an image after changing, in association with each other.

In step S03 of FIG. 3, the PC selects the entry to be used (hereinafter, “second entry”), from the first entry 1E, according to the processing intensity.

For example, the PC extracts an area in part of the input image, and generates an image patch. Next, the PC calculates the feature amount of the image patch.

Note that the feature amount is a value indicating the distribution of pixel values indicated by the pixels included in the image. For example, the feature amount is a pixel value, a value obtained by performing first derivation or second derivation on the pixel value, SIFT (Scale-Invariant Feature Transform), SURF (Speeded Up Robust Features), LBP (Local Binary Pattern), or a value calculated by a combination of these values. Furthermore, the feature amount is indicated by a vector format. In the following, a vector indicating a feature amount is referred to as a feature amount vector.

When a feature amount vector is calculated, for example, the PC combines a unit vector and a weight coefficient, and expresses the feature amount vector.

A basic vector is a vector determined based on the low-resolution patch; however, the basic vector is not limited to being determined based on the low-resolution patch, for example, the basic vector may be determined based on a high-resolution patch. Specifically, as the basic vector, the low-resolution patch or a feature amount vector of the low-resolution patch is used. Furthermore, the basic vector may be a vector obtained by applying principal component analysis, etc., on the low-resolution patch or the feature amount vector of the low-resolution patch, and standardizing the vector to reduce the dimension of the vector or to make the length of the vector become “1”, such that the vector is converted into a unit vector.

Furthermore, a basic vector may be alternatively used instead of the low-resolution patch in the entry of the dictionary data. That is, the entry may store the basic vector and the high-resolution patch in association with each other, instead of storing the low-resolution patch and the high-resolution patch in association with each other.

In the following, a description is given of an example where the entry of the dictionary data stores a basic vector and a high-resolution patch in association with each other.

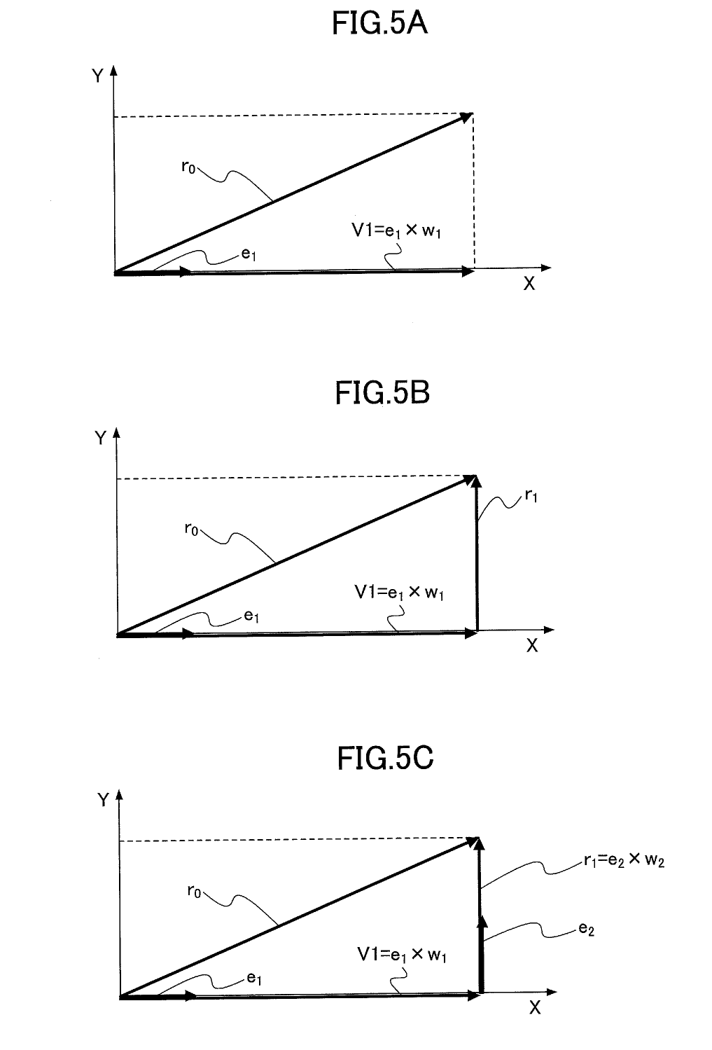

FIGS. 5A through 5C illustrate an example of a process relevant to the feature amount vector performed by the image processing apparatus according to an embodiment of the present invention. In the following, a description is given of an example of two-dimensional coordinates indicated by an X axis and a Y axis orthogonal to the X axis, as illustrated in FIGS. 5A through 5C. Furthermore, in FIGS. 5A through 5C, the feature amount vector to be expressed is referred to as a target vector r₀.

First, the PC obtains a first vector V1. Specifically, the first vector V1 is obtained by searching the first entry for a vector by which the inner product with the target vector r₀ is maximized. Note that the searched vector is a first basic vector, and the first basic vector is, for example, a unit vector e₁ (hereinafter, “first unit vector”) that is orthogonal to the Y axis. In the following, a description is given of an example in which the first unit vector e₁ illustrated in FIG. 5A is used as the first basic vector. Note that a first basic vector may be a vector having any length, other than the unit vector.

Furthermore, the PC can obtain a weight coefficient w₁ (hereinafter, “first weight coefficient”) relevant to the first unit vector e₁, from the inner product with the target vector r₀. That is, for example, the first vector V1 may be obtained as a vector corresponding to the X axis component of the target vector r₀, as illustrated in FIG. 5A.

Next, as illustrated in FIG. 5B, the PC obtains a residual vector r_{1.} Note that the residual vector r₁ is a vector indicating the difference between the target vector r₀ and the first vector V1 (hereinafter, “residual vector”). Furthermore, the PC can obtain the residual vector r₁ from a combination of a second basic vector and a weight coefficient w₂ (hereinafter, “second weight coefficient”) relevant to the second basic vector. Specifically, for example, as illustrated in FIG. 5C, the PC obtains the residual vector r₁ for a combination of a unit vector e₂ (hereinafter, “second unit vector”) that is orthogonal to the X axis as the second basic vector, and the second weight coefficient w_{2.} In the following, a description is given of an example where the second unit vector e₂ illustrated in FIG. 5C is used as the second basic vector.

Note that FIGS. 5A through 5C illustrate an example in which the difference between the target vector r₀, and a vector expressed by the first vector V1 and a second vector V2 described below, is zero. Therefore, FIGS. 5A through 5C illustrate a case where the PC does not obtain any more entries of the dictionary. Meanwhile, when the first unit vector e₁ and the second unit vector e₂ are respectively not components that are orthogonal to the target vector r₀, the difference according to the first vector V1 and the second vector V2 described below may not become zero. When the difference is not zero, the PC may obtain another vector from the first entry to reduce the difference. Assuming that the residual vector is rₖ (k=1, 2, and so on), the residual vector rₖ can be expressed by the following formula (1).

$$\begin{matrix}Formula ( 1 ) & \\ {r}_{k} = {r}_{0} - {\sum }_{i = 1}^{k} {w}_{i} \cdot {e}_{i} & ( 1 )\end{matrix}$$

Furthermore, the unit vector is not limited to a vector that is orthogonal to one of the axes. The figures merely illustrate an X axis and a Y axis as a matter of convenience.

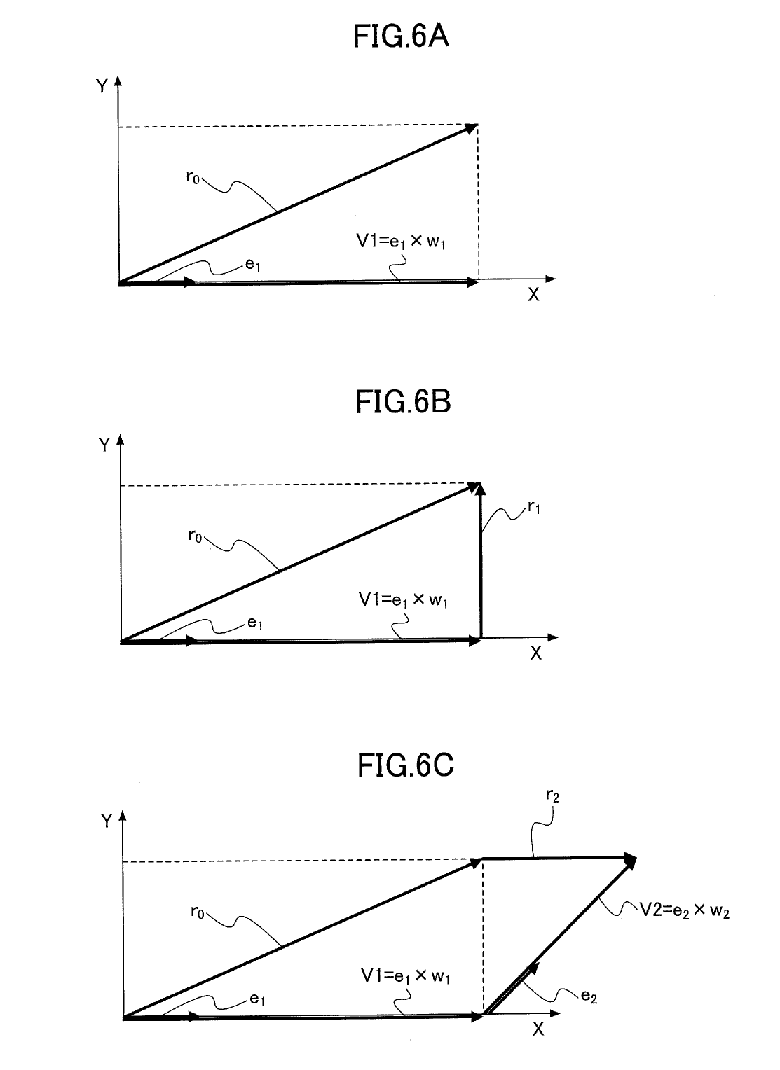

FIGS. 6A through 6C illustrate another example of a process relevant to the feature amount vector performed by the image processing apparatus according to an embodiment of the present invention. Specifically, FIGS. 6A through 6C illustrate an example of expressing the same target vector r₀ as that of FIG. 5A. That is, the target vector r₀ illustrated in FIG. 6A, which is to be expressed by the process illustrated in FIGS. 6A through 6C, is assumed to be the same as that of FIG. 5A.

Furthermore, in the process illustrated in FIGS. 6A through 6C, it is assumed that the first unit vector e₁ and the first weight coefficient w₁ are obtained, similar to FIG. 5B. That is, the first vector V1 of FIGS. 6A through 6C is the same as that of FIG. 5B, and the residual vector r₁ obtained by the first vector V1 is also the same as that of FIG. 5B.

Next, as illustrated in FIG. 6C, the PC combines the second unit vector e₂, which has an angle with respect to the X axis, and the second weight coefficient w₂, such that the residual vector r₂ becomes minimum. Furthermore, a vector obtained by combining the second unit vector e₂ and the second weight coefficient w₂ is set as the second vector V2.

Therefore, in FIGS. 6A through 6C, there is a difference between a vector expressed by the first vector V1 and the second vector V2, and the target vector r₀. In this case, as illustrated in FIG. 6C, the difference is expressed by a residual vector r₂. Note that the residual vector r₂ can be obtained by the above formula (1).

Furthermore, when there are many kinds of unit vectors, the PC can use many unit vectors, and therefore the PC can reduce the difference between the vector expressed by the first vector V1 and the second vector V2, and the target vector r₀. Accordingly, when there are a large number of second entries, the PC can reduce the difference between the vectors expressed by the first vector V1 and the second vector V2, and the target vector r₀, and therefore the image can be restored with high precision.

Furthermore, in step S03 of FIG. 3, the PC selects an entry to be the second entry, from the first entry 1E (FIG. 4), such that the difference between a vector expressed by the first vector V1 and the second vector V2, and the target vector r₀ that is the feature amount vector of the image patch, becomes minimum. That is, in step S03, the PC selects a second entry from the first entry 1E, such that the residual vector rₖ of formula (1) above becomes minimum. Furthermore, in step S03, as illustrated in FIGS. 5A through 5C and FIGS. 6A through 6C, the PC calculates a weight coefficient wₖ relevant to the second entry, in association with the second entry.

Therefore, the weight coefficient wₖ is preferably a coefficient that is calculated from the feature amount vector of the image patch indicating the difference, in order to reduce the residual vector rₖ. Specifically, the weight coefficient wₖ is preferably a value calculated based on the inner product of two vectors. Note that the weight coefficient wₖ may be a constant value or a similarity degree, etc., set in advance. For example, the similarity degree is an inverse number such as a manhattan distance or a mahalanobis distance indicating the distance between the target vector and each vector such as the first vector or the second vector, etc.

Furthermore, the PC generates image patches for the respective areas included in the input image input in step S01 (FIG. 3), and therefore step S03 is repeated for each of the image patches. Note that the image patches may be extracted such that the areas indicated by the respective image patches do not overlap each other, or the image patches may be extracted such that the areas partially overlap each other.

### (Example of Storing Intermediate Data (Step S04))

Referring back to FIG. 3, in step S04, the PC stores intermediate data.

The intermediate data is data identifying a second entry selected in step S03. That is, the intermediate data is data that can identify a single entry. Specifically, the intermediate data is data indicating an ID (identification) for identifying an entry, or copy data obtained by copying the data of an entry, etc. Furthermore, when the processes of FIGS. 5A through 5C and FIGS. 6A through 6C are performed by using intermediate data, the PC can identify one of or both of the first unit vector e₁ and the second unit vector e₂, by the intermediate data Therefore, by using the intermediate data, the PC is able to reduce the processing load for searching for a unit vector.

Furthermore, in the intermediate data, a weight coefficient wₖ may be stored in association with each entry that is identified. When a weight coefficient wₖ is stored in the intermediate data, and the process of, for example, FIGS. 5A through 5C is performed by using the intermediate data, the PC can refer to the weight coefficient wₖ stored in the intermediate data when obtaining the first vector V1 and the second vector V2. Thus, when a weight coefficient wₖ is stored in the intermediate data, the PC can omit part of or all of the processes for obtaining the weight coefficient wₖ, among the processes for obtaining the first vector V1, the second vector V2, etc. Therefore, by the intermediate data, the PC can reduce the processing load of processes relevant to the feature amount vector.

Note that, in the intermediate data, a plurality of entries and weight coefficients wₖ may be stored with respect to a single image patch.

Furthermore, the residual vector rₖ of the above formula (1) changes according to the entry being used, and therefore in the intermediate data, the order in which the second entries are used and the residual vectors rₖ, are preferably stored.

### (Example of Generating Second Image Based on Intermediate Data (Step S05))

In step S05, the PC generates an image (hereinafter, “second image”) by performing image processing on the first image, based on the intermediate data. Specifically, in step S05, the PC first identifies a second entry based on the intermediate data. Furthermore, when the intermediate data stores a weight coefficient wₖ, the PC may acquire the weight coefficient wₖ corresponding to the second entry identified based on the intermediate data.

Next, in step S05, the PC multiplies the high-resolution patch PH (FIG. 4), among the data included in the second entry identified by the intermediate data, by the weight coefficient, and generates a combination patch by adding the high-resolution patch PH multiplied by the weight coefficient, to the image patch. Note that the weight coefficient is the weight coefficient wₖ acquired based on the intermediate data, or a value that is calculated by the processes illustrated in FIGS. 5A through 5C or FIGS. 6A through 6C.

Furthermore, in step S05, the PC superimposes the generated combination patches on the respective areas included in the first image. Specifically, the PC performs the superimposition by replacing the pixels included in the first image with the pixels included in the combination patches. Note that the PC may perform the superimposition by adding the pixel values indicated by the respective pixels included in the combination patches to the pixel values indicated by the respective pixels included in the first image.

Note that when the image patches are extracted such that part of the areas overlap each other, the process of superimposing the combination patches is preferably performed by applying a weighted average.

### (Example of Outputting Preview Image (Step S06))

In step S06 the PC outputs the preview image.

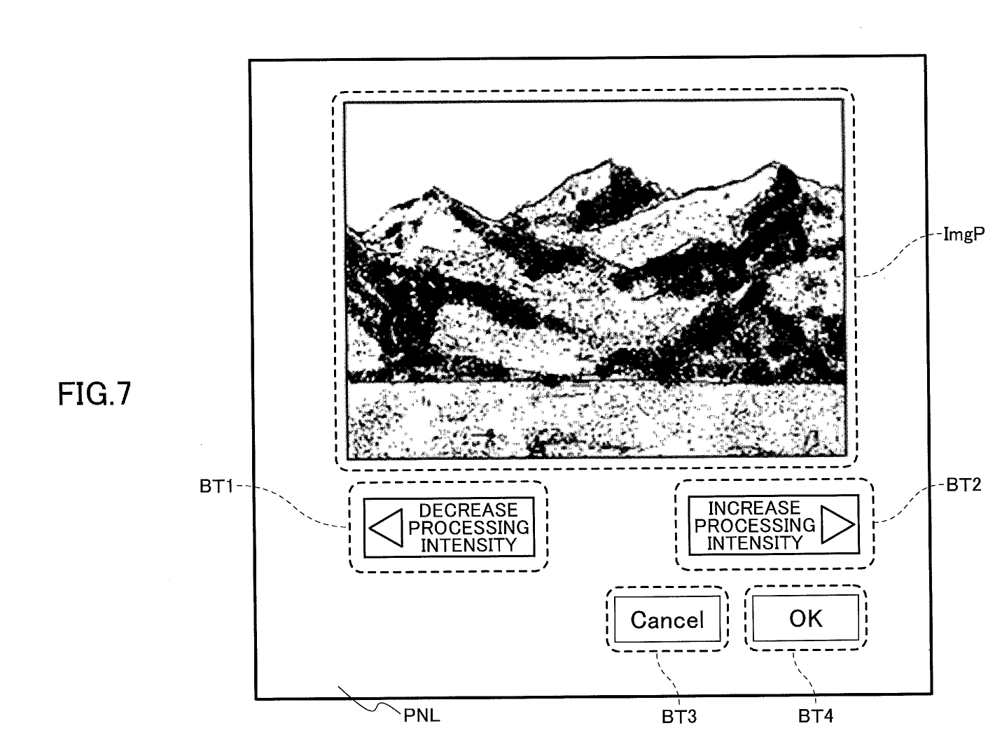

FIG. 7 illustrates an example of a preview image output by the image processing apparatus according to an embodiment of the present invention. Specifically, FIG. 7 illustrates an example of a screen PNL displayed by the PC.

For example, the screen PNL displays the second image generated in step S05 (FIG. 3), as the preview image ImgP. Furthermore, the screen PNL includes a GUI (Graphical User Interface) such as a first button BT1, a second button BT2, a third button BT3, a fourth button BT4, etc., for the USER (FIG. 1) to input an operation M (FIG. 1).

In the screen PNL, the USER presses either one of the first button BT1 or the second button BT2, to input an operation M to instruct the processing intensity to the PC. For example, when the USER makes an evaluation that the processing intensity on the displayed preview image ImgP is too high, the USER presses the first button BT1. Meanwhile, when the USER makes an evaluation that the processing intensity on the displayed preview image ImgP is too low, the USER presses the second button BT2.

Note that when the processing intensity of generating the second image displayed as the preview image ImgP is maximum, the PC may display the screen PNL such that the second button BT2 is invalidated. Similarly, when the processing intensity of generating the second image displayed as the preview image ImgP is minimum, the PC may display the screen PNL such that the first button BT1 is invalidated.

In the screen PNL, the USER presses the fourth button BT4 to input an operation M of determining the output image. That is, when the USER makes an evaluation that the processing intensity on the displayed preview image ImgP is optimum, the USER presses the fourth button BT4 and determines the second image, which is displayed as the preview image ImgP, to be the output image.

Note that when instructing the PC to end the overall process, in the screen PNL, the USER presses the third button BT3. That is, when the third button BT3 is pressed, the PC ends the overall process illustrated in FIG. 3.

Furthermore, the screen PNL may display the first image as the preview image ImgP.

### (Example of Determining Whether the Processing Intensity Has Been Changed (Step S07))

Referring back to FIG. 3, in step S07, the PC determines whether the processing intensity has been changed. Specifically, when the screen PNL illustrated in FIG. 7 is displayed in step S06, and the first button BT1 or the second button BT2 is pressed, the PC determines that the processing intensity has been changed (YES in step S07). Meanwhile, when the screen PNL is displayed, and the fourth button BT4 (FIG. 7) is pressed, the PC determines that the processing intensity will not be changed (NO in step S07).

Furthermore, in step S07, when the PC determines that the processing intensity has been changed, the PC returns to step S03. Meanwhile, in step S07, when the PC determines that the processing intensity will not be changed, the PC proceeds to step S08.

### (Example of Outputting Output Image (Step S08)

In step S08, the PC outputs an output image. Specifically, in step S08, the PC outputs the second image determined as the output image in step S06, to an output device such as a display or a printer, etc. Furthermore, in step S08, the PC may output image data indicating the second image, to a recording medium, etc.

### (Example of Process Result)

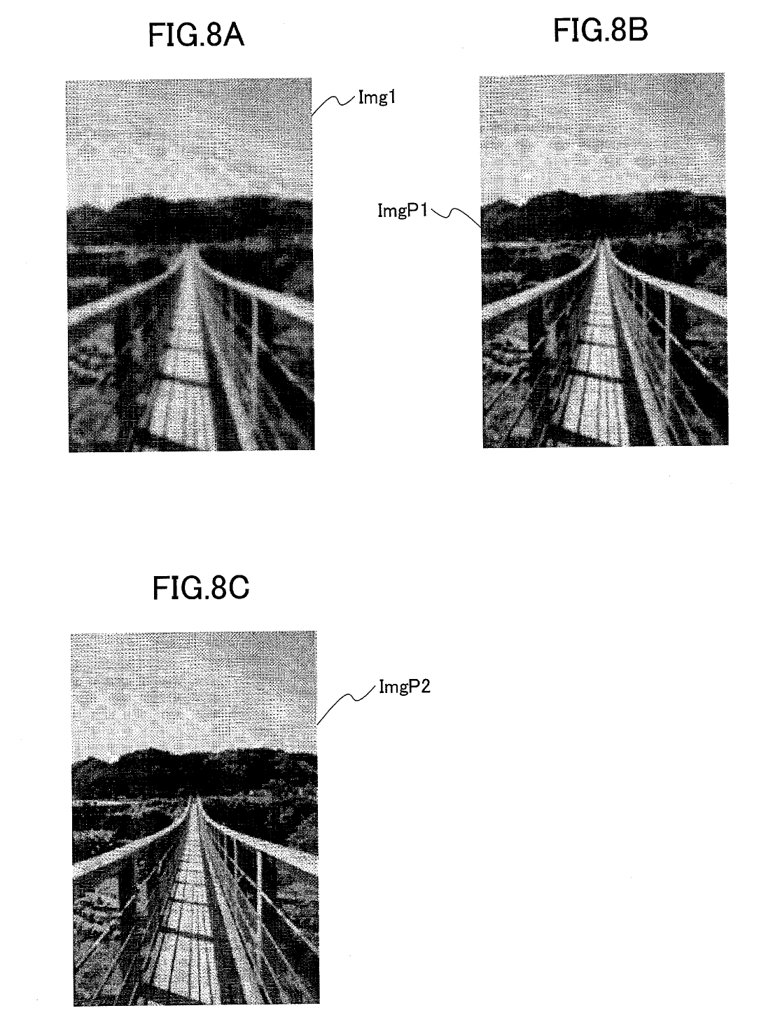

FIGS. 8A through 8C illustrate an example of a process result of the overall process by the image processing apparatus according to an embodiment of the present invention. Specifically, FIGS. 8A through 8C illustrate an example of setting the image illustrated in FIG. 8A as a first image Img1.

For example, the PC performs steps S03 through S05 illustrated in FIG. 3 with respect to the first image Img1, and generates a first preview image ImgP1 illustrated in FIG. 8B, as one preview image. Note that the first preview image ImgP1 is an example of an image in which the high frequency components of the first image Img1 are restored by steps S03 through S05. Thus, the first preview image ImgP1 is an image that has undergone image processing such that the restoration degree of high frequency components is high. Note that when the first preview image ImgP1 is generated, the PC stores, in step S04 (FIG. 3), the intermediate data identifying the second entry, etc., used when generating the first preview image ImgP1.

Next, the PC performs steps S03 through S05 again, and generates another preview image. For example, there is a case where the first preview image ImgP1 is displayed in step S06 (FIG. 3), and the user makes an evaluation that in the first preview image ImgP1, the restoration degree of high frequency components is low, and that the processing intensity is too low (YES in step S07 (FIG. 3). In this case, the PC performs steps S03 through S05 again on the first image Img1 by a different processing intensity than that used for generating the first preview image ImgP1, and generates a second preview image ImgP2 illustrated in FIG. 8C as another preview image.

The second preview image ImgP2 is an example of an image having a higher sharpness than that of the first preview image ImgP1. Therefore, in the process of generating the second preview image ImgP2, the number of second entries is larger than the case of generating the first preview image ImgP1.

The PC generates the second preview image ImgP2 by using the intermediate data stored when generating the first preview image ImgP1. Specifically, when generating the second preview image ImgP2, in step S03, the PC selects, from the first entry 1E (FIG. 4), an entry other than those identified by the intermediate data, and adds the selected entry. Note that the PC may add a plurality of entries.

That is, when the PC uses the intermediate data, the entries used when generating the first preview image ImgP1 can be identified among the second entries. Therefore, when the intermediate data is used, the PC can omit part of or all of the processes of identifying the entries used when generating the first preview image ImgP1 among the second entries, and the processing load can be reduced.

Note that the intermediate data may store the weight coefficient used for generating the first preview image ImgP1. When the intermediate data stores a weight coefficient, the PC can omit part of or all of the processes of calculating the first vector V1 (FIGS. 5A through 5C, etc.) based on the second entry, and the processing load can be reduced.

Furthermore, as the method of acquiring an entry from dictionary data and the method of obtaining a weight coefficient, for example, the methods described in either one of the following documents may be used

Chang, Hong, Dit-Yan Yeung, and Yimin Xiong, “Super-resolution through neighbor embedding.” Computer Vision and Pattern Recognition, 2004. CVPR 2004. Proceedings of the 2004 IEEE Computer Society Conference on. Vol.1 IEEE,2004.”

Yang, Jianchao, et al. “Image super-resolution via sparse representation.” Image Processing, IEEE Transactions on 19.11 (2010): 2861-2873.

### (Modification Example)

In the first embodiment, a pair of a high-resolution patch and a low-resolution patch is stored in the entry of the dictionary data. However, the entry of the dictionary is not so limited.

For example, by using a method described in Yang, Jianchao, et al. “Image super-resolution via sparse representation.” Image Processing, IEEE Transactions on 19.11 (2010): 2861-2873., etc., the PC may resolve the image patch into a basic structural element referred to as a base, and may store a pair of a high-resolution base and a low-resolution base as an entry of the dictionary data. That is, the PC may replace the high-resolution patch and the low-resolution patch of the first embodiment with a high-resolution base and a low-resolution base, respectively.

Therefore, in step S03 (FIG. 3), the basic vector, which is used when selecting the entry to be used (second entry) from the first entry, is a vector derived from the low-resolution base or the feature amount vector of the low-resolution base.

Furthermore, in step S05 (FIG. 3), when generating the combination patch, the PC does not multiply the high-resolution patch by the weight coefficient, but instead multiplies the high-resolution base by the weight coefficient, and generates the combination patch by adding the high-resolution base that has been multiplied by the weight coefficient, to the image patch.

### Second Embodiment

In a second embodiment, for example, the PC 1 having the hardware configuration illustrated in FIG. 2 is used. Furthermore, in the second embodiment, the PC 1 performs the overall process illustrated in FIG. 3. Therefore, descriptions of the hardware configuration and the overall process are omitted. The second embodiment is different from the first embodiment in terms of the process relevant to the intermediate data In the following, the points that are different from those of the first embodiment are mainly described.

In the second embodiment, the intermediate data includes a weight coefficient. When generating a plurality of preview images (YES in step S07 (FIG. 3), the PC uses the data identifying the second entry and the weight coefficient stored as intermediate data, to select an entry, etc.

In the following, a description is given of a process according to the second embodiment by using the example illustrated in FIGS. 8A through 8C.

First, in the second embodiment, similar to the first embodiment, the PC generates a first preview image ImgP1. Next, when the user makes an evaluation that the processing intensity is too low (YES in step S07), the PC uses the intermediate data stored when generating the first preview image ImgP1, to further generate a second preview image ImgP2.

In the second embodiment, when generating the second preview image ImgP2, the PC calculates the weight coefficient. Next, in step S04 (FIG. 3) according to the second embodiment, the PC updates the intermediate data by the weight coefficient calculated when generating the second preview image ImgP2. That is, in the intermediate data, the weight coefficient calculated when generating the first preview image ImgP1 is stored. Furthermore, in the second embodiment, the intermediate data is updated by overwriting the weight coefficient calculated when generated the first preview image ImgP1, with the weight coefficient calculated when generating the second preview image ImgP2.

When the PC generates the second preview image ImgP2 after generating the first preview image ImgP1, the PC adds a new entry, selected from the first entry 1E (FIG. 3). In the following, a description is given of the example illustrated in FIG. 6C. When the second unit vector e₂ is added, the PC adds an entry, such that the residual vector r₂ becomes minimum, according to the first unit vector e₁ and the first weight coefficient w₁, and the second unit vector e₂ and the second weight coefficient w₂, identified by the intermediate data. Furthermore, in the second embodiment, the PC calculates the first weight coefficient w₁ by which the residual vector r₂ becomes minimum, changes the value included in the intermediate data by the calculated value, and adds the entry of the second unit vector e₂.

It is difficult for the PC to prepare dictionary data D1 (FIG. 4) constantly including unit vectors that are orthogonal to each other, as illustrated in FIGS. 5A through 5C. Therefore, the PC selects a second entry and calculates a weight coefficient such that the residual vector rₖ is as small as possible, as illustrated in FIGS. 6A through 6C. Thus, when the PC can change the weight coefficient according to the second entry as in the second embodiment, the PC can further decrease the residual vector rₖ of the above formula (1). Therefore, by updating the weight coefficient, the PC can restore the image even more precisely.

Note that in the second embodiment, the PC may calculate the weight coefficient, by using the weight coefficient stored as the intermediate data as an initial value of the process illustrated in FIGS. 5A through 5C or FIGS. 6A through 6C. Furthermore, as the weight coefficient changes according to the processing intensity, the calculated weight coefficient is preferably added to the intermediate data in association with the processing intensity. Furthermore, the weight coefficient included in the intermediate data may be updated by being overwritten by a weight coefficient calculated in association with the processing intensity, etc.

### Third Embodiment

In a third embodiment, for example, the PC 1 having the hardware configuration illustrated in FIG. 2 is used. Furthermore, in the third embodiment, the PC 1 performs the overall process illustrated in FIG. 3. Therefore, descriptions of the hardware configuration and the overall process are omitted. The third embodiment is different from the first embodiment in terms of the process relevant to the intermediate data. In the following, the points that are different from those of the first embodiment are mainly described.

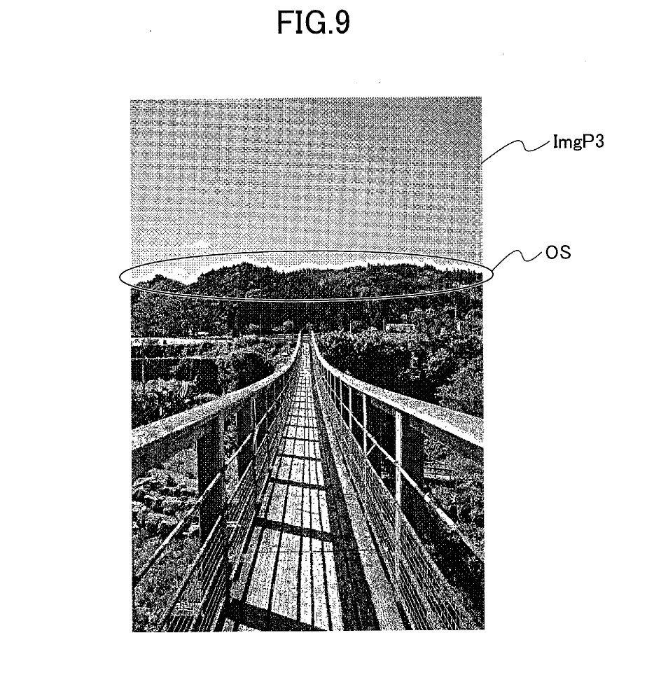

FIG. 9 illustrates an example of a preview image according to the third embodiment of the present invention. Specifically, FIG. 9 illustrates an example of a preview image generated when the image illustrated in FIG. 8A is the first image Img1.

In the third embodiment, for example, it is assumed that the PC performs steps S03 through S05 illustrated in FIG. 3 on the first image Img1, and a third preview image ImgP3 illustrated in FIG. 9 is generated as a preview image. Note that the third preview image ImgP3 is an example of an image in which the high frequency components of the first preview image ImgP1 are restored, by steps S03 through S05 of high processing intensity. Thus, the third preview image ImgP3 is an image that has undergone image processing such that the sharpness is higher than that of the first preview image ImgP1. Note that when the third preview image ImgP3 is generated, in step S04 (FIG. 3), the PC stores the intermediate data identifying the second entry, etc., used when generating the third preview image ImgP3.

When the processing intensity is too high, for example, there are cases where an area OS (hereinafter, “overshoot area”), in which so-called overshoot occurs at the edge parts, etc., is generated in the second image. Note that the overshoot area OS is an area where the edge is excessively emphasized or an area that is too bright, etc., as illustrated in FIG. 9.

In this case, the PC performs steps S03 through S05 again on the first image Img1 by a different processing intensity than that used for generating the first preview image ImgP1, and generates another preview image. Specifically, when the third preview image ImgP3 is displayed in step S06 (FIG. 3), and the third preview image ImgP3 includes an overshoot area OS, the user makes an evaluation that the processing intensity is too high (YES in step S07 (FIG. 3)). In this case, the PC performs steps S03 through S05 again on the first image Img1, and a second preview image ImgP2 illustrated in FIG. 8C is generated as another preview image. In the following, a description is given of an example where the PC generates the second preview image ImgP2 again after generating the third preview image ImgP3.

The third preview image ImgP3 is an example of an image having a higher sharpness than that of the second preview image ImgP2. Thus, the process of generating the third preview image ImgP3 includes a higher number of second entries than the process of generating the second preview image ImgP2.

The PC uses the intermediate data stored when generating the third preview image ImgP3, to generate another second preview image ImgP2. Specifically, when generating another second preview image ImgP2, in step S03, the PC selects a second entry from the entries identified by the intermediate data. Therefore, by using the intermediate data, the PC does not need to add an entry in the process of generating the second preview image ImgP2.

Thus, by using the intermediate data, the PC can identify a second entry from the entry used when generating the third preview image ImgP3. When generating an image having a low processing intensity, the number of second entries is lower than the case of generating an image having a high processing intensity. Accordingly, the process of generating an image having a low processing intensity can be performed with the entry identified by the intermediate data stored when generating an image having a high processing intensity. Therefore, when the intermediate data is used, the PC can omit part of or all of the processes of selecting a second entry, and the processing load can be reduced.

Note that in the third embodiment, as described in the second embodiment, the PC can update or add the weight coefficient. When the processing intensity changes, the weight with respect to each entry changes, and therefore the PC may be able to reduce the residual vector by updating or adding the weight coefficient. Therefore, by updating or adding the weight coefficient, the PC can restore the image even more precisely.

### Fourth Embodiment

In a fourth embodiment, for example, the PC 1 having the hardware configuration illustrated in FIG. 2 is used. Furthermore, in the fourth embodiment, the PC 1 performs the overall process illustrated in FIG. 3. Therefore, descriptions of the hardware configuration and the overall process are omitted. The fourth embodiment is different from the first embodiment in terms of the method of expressing the feature amount vector. In the following, the points that are different from those of the first embodiment are mainly described.

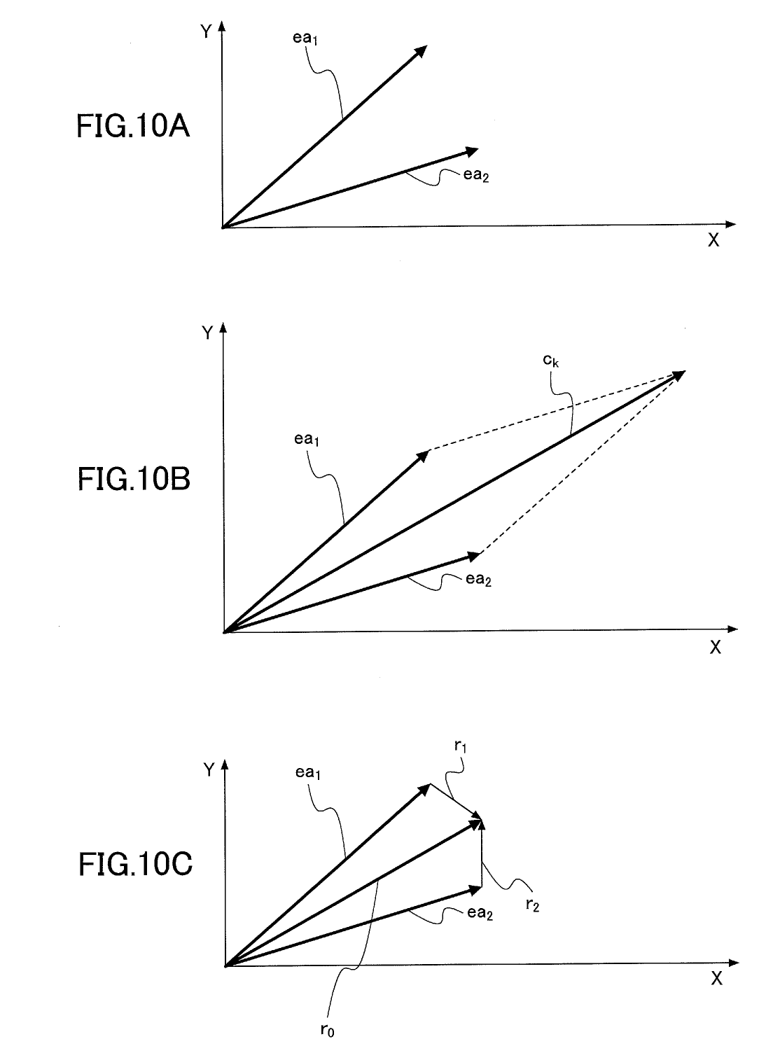

FIGS. 10A through 10C illustrate an example of a process relevant to the feature amount vector performed by the image processing apparatus according to the fourth embodiment of the present invention. Similar to FIGS. 5A through 5C, in the following, a description is given of an example of two-dimensional coordinates indicating by an X axis and a Y axis orthogonal to the X axis. Furthermore, similar to FIGS. 5A through 5C, in the following, the feature amount vector to be expressed is referred to as a target vector.

First, the PC obtains a first similar vector ea₁, which is most similar to the target vector, from the first entry 1E (FIG. 4), according to a similarity degree, etc. Next, from the first entry 1E, the PC obtains a second similar vector ea₂, which is second most similar to the target vector next to the first similar vector ea₁ according to a similarity degree, etc. Note that, for example, the first similar vector ea₁ and the second similar vector ea₂ are vectors illustrated in FIG. 10A.

Furthermore, the PC generates a combination vector cₖ, for example, as illustrated in FIG. 10B. The combination vector cₖ is obtained by combining a third vector and a fourth vector. The third vector is obtained by combining the first similar vector ea₁ and a weight coefficient wa₁, and the fourth vector is obtained by combining the second similar vector ea₂ and a weight coefficient wa₂. Note that the combination vector cₖ is defined by the following formula (2).

$$\begin{matrix}Formula ( 2 ) & \\ {c}_{k} = \frac{1}{Z} {\sum }_{i = 1}^{k} {wa}_{i} \cdot {ea}_{i} & ( 2 )\end{matrix}$$

Here, Z is a constant for standardization, which is defined by the following formula (3).

$$Z = {\sum }_{i = 1}^{k} {wa}_{i} \qquad ( 3 )$$

Furthermore, waₖ is the weight coefficient. For example, as the weight coefficient waₖ, the inner product of the target vector and the combination vector cₖ, or an inverse number of the respective lengths |rₖ| of the residual vectors rₖ illustrated in FIG. 10C may be used.

That is, in the fourth embodiment, in order to express the feature amount vector, the PC selects a similar vector as the second entry, and generates a combination vector cₖ, which is a combination of a plurality of similar vectors. Therefore, in the fourth embodiment, the intermediate data is data for identifying a similar vector eaₖ.

For example, similar to the first embodiment, when the PC generates a second preview image ImgP2 (FIG. 8C) after generating the first preview image ImgP1 (FIG. 8B), the PC adds a new entry from the first entry 1E (FIG. 4). Furthermore, the second preview image ImgP2 is an image having a higher sharpness than the first preview image ImgP1, and therefore the process of generating the second preview image ImgP2 includes a higher number of second entries than the process of generating the first preview image ImgP1.

The PC generates the second preview image ImgP2 by using the intermediate data stored when generating the first preview image ImgP1. Specifically, when generating the second preview image ImgP2, in step S03, the PC selects, from the first entry 1E (FIG. 4), an entry other than those identified by the intermediate data, and adds the selected entry.

That is, when the PC uses the intermediate data, the entry used when generating the first preview image ImgP1 can be identified among the second entries. Therefore, when the intermediate data is used, the PC can omit part of or all of the processes of identifying the entry used when generating the first preview image ImgP1 among the second entries, and the processing load can be reduced. Furthermore, by the method of expressing the feature amount vector illustrated in FIGS. 10A through 10C, the PC can restore characters, etc., even more precisely.

### (Modification Example)

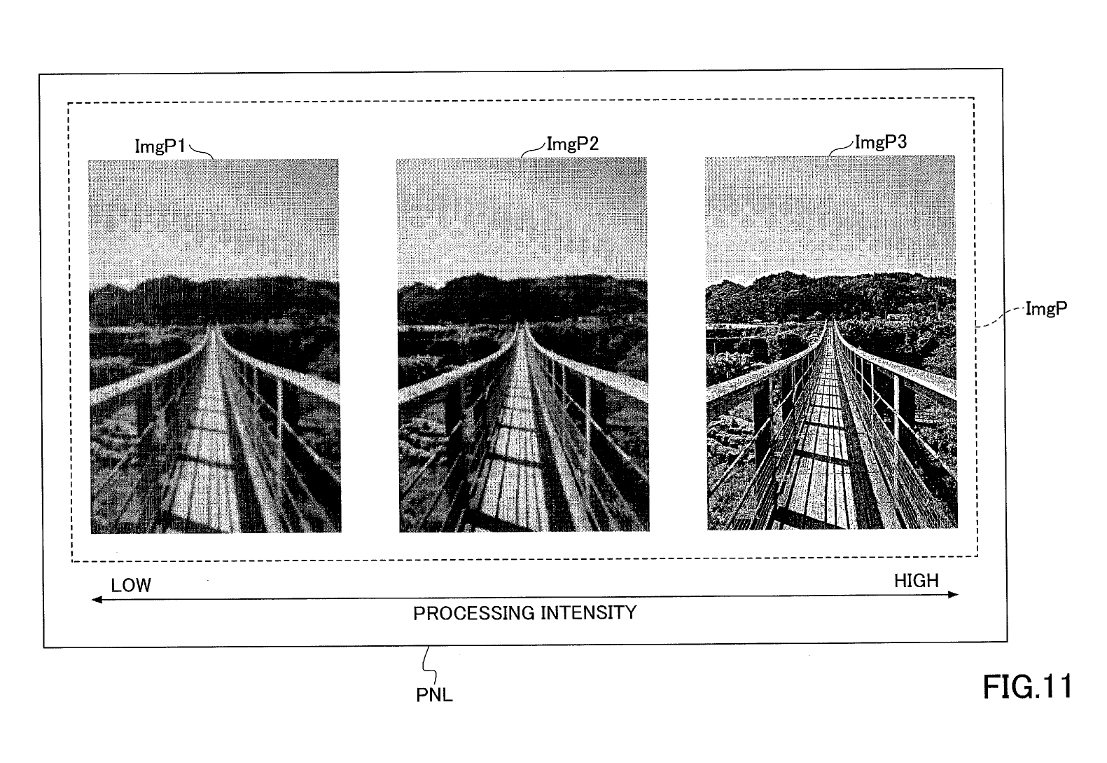

FIG. 11 illustrates an example of a screen displaying preview images, etc., by the image processing apparatus according to an embodiment of the present invention. Specifically, a screen PNL used for displaying a plurality of preview images ImgP and for inputting operations M (FIG. 1) by the user, may be a screen for displaying a plurality of preview images, as illustrated in FIG. 11. In the following, a description is given of an example where the screen PNL of FIG. 11 is displayed.

When the PC displays the screen PNL illustrated in FIG. 11, the PC generates a first preview image ImgP1 through a third preview image ImgP3, before performing step S06 indicated in FIG. 3. Therefore, before performing step S06 indicated in FIG. 3, the PC performs steps S03 through S05 for generated the respective preview images.

For example, the PC sequentially generates the preview images starting from the preview image of low processing intensity, among the plurality of preview images ImgP. Specifically, first, the PC performs steps S03 through S05 for generating the first preview image ImgP1 having the lowest processing intensity, among the first preview image ImgP1 through the third preview image ImgP3.

Next, the PC performs steps S03 through S05 again for generating the second preview image ImgP2 having the second lowest processing intensity. In this case, the PC can identify the second entry used when generating the first preview image ImgP1 by the intermediate data, and therefore the PC can reduce the processing load of the process of generating the second preview image ImgP2, compared to the case of not using the intermediate data.

Furthermore, the PC performs steps S03 through S05 again for generating the third preview image ImgP3. In this case, the PC can identify the second entry used when generating the first preview image ImgP1 and the second preview image ImgP2, by the intermediate data. Therefore, the PC can reduce the processing load of the process of generating the third preview image ImgP3, compared to the case of not using the intermediate data. Furthermore, in the screen PNL illustrated in FIG. 11, a plurality of preview images are displayed, and therefore the user can easily compare the images and make evaluations.

Note that the PC may sequentially generate the preview images starting from the preview image of high processing intensity, among the plurality of preview images ImgP. When the preview images are sequentially generated starting from the preview image of high processing intensity, the PC sequentially generates the respective preview images by, for example, the method described in the third embodiment. In this case, the PC can reduce the processing load of the process of generating the first preview image ImgP1 and the second preview image ImgP2, compared to the case of not using the intermediate data.

### (Example of Functional Configuration)

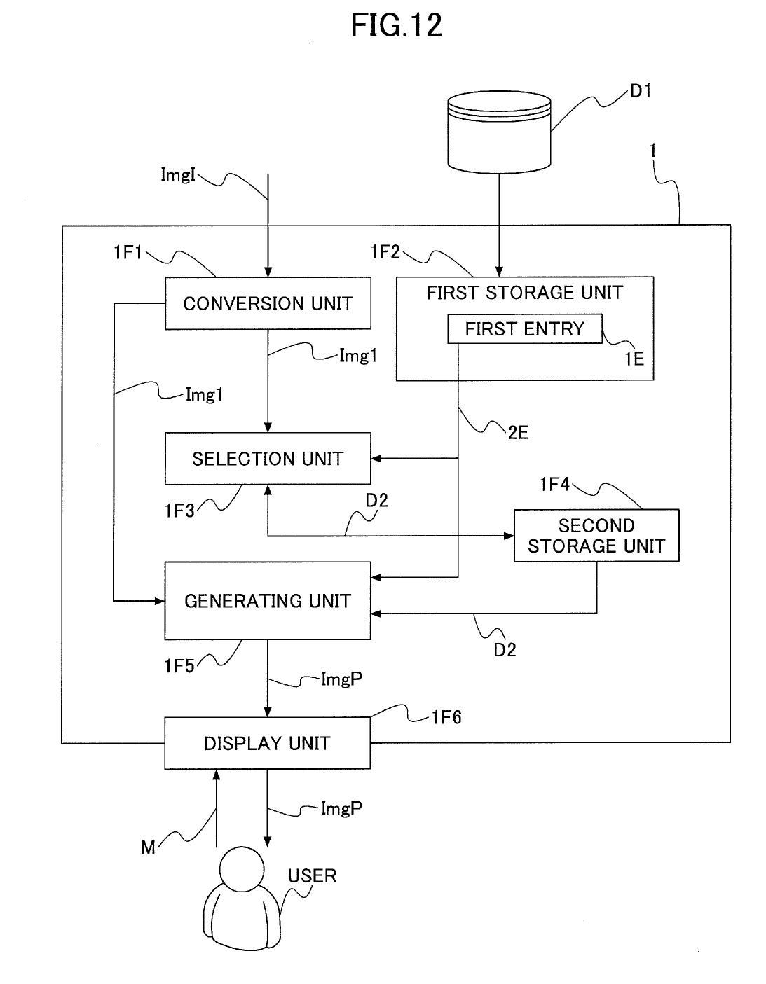

FIG. 12 is a functional block diagram of an example of an image processing apparatus according to an embodiment of the present invention. Specifically, the PC1 includes a conversion unit 1F1, a first storage unit 1F2, a selection unit 1F3, a second storage unit 1F4, a generating unit 1F5, and a display unit 1F6.

The conversion unit 1F1 inputs an input image ImgI, and generates a first image Img1 from the input image ImgI. Note that the conversion unit 1F1 is realized by, for example, the CPU 1H1 (FIG. 2), the input I/F 1H3 (FIG. 2), etc.

The first storage unit 1F2 inputs the dictionary data D1, and stores an entry indicating an image before the image is changed and the image after the image has been changed, as a first entry 1E. Note that the first storage unit 1F2 is realized by, for example, the storage device 1H2 (FIG. 2).

The selection unit 1F3 calculates a feature amount vector from the first image Img1, and selects a second entry 2E from the first entry 1E, etc., stored in the first storage unit 1F2, based on the feature amount vector, the processing intensity, etc. Furthermore, when the intermediate data D2 is stored, the selection unit 1F3 selects the second entry 2E based on the intermediate data D2. Note that the selection unit 1F3 is realized by, for example, the CPU 1H1, etc.

The second storage unit 1F4 stores the intermediate data D2 identifying the second entry 2E selected by the selection unit 1F3. Note that the second storage unit 1F4 is realized by, for example, the storage device 1H2, etc.

The generating unit 1F5 identifies the second entry 2E based on the intermediate data D2 stored in the second storage unit 1F4, performs image processing on the first image Img1 based on the identified second entry 2E, and generates a preview image ImgP as the second image. Note that the generating unit 1F5 is realized by, for example, the CPU 1H1, etc.

The display unit 1F6 displays the preview image ImgP generated by the generating unit 1F5, to the USER. Furthermore, the display unit 1F6 inputs an operation M by the USER, such as an instruction of the processing intensity. Note that the display unit 1F6 is realized by, for example, the input device 1H4 (FIG. 2), the output I/F 1H6 (FIG. 2), etc.

The PC 1 generates the first image Img1 by magnifying the input image ImgI by the conversion unit 1F1, etc. Furthermore, the PC 1 inputs the dictionary data D1 and stores the first entry 1E by the first storage unit 1F2. Furthermore, the PC 1 calculates, by the selection unit 1F3, the feature amount vector from the first image Img1, and selects the second entry 2E based on the feature amount vector, the processing intensity, etc. Furthermore, the PC 1 stores, by the second storage unit 1F4, the intermediate data D2 identifying the second entry 2E selected by the selection unit 1F3.

When the intermediate data D2 is stored, the PC 1 can identify the second entry 2E by the intermediate data D2. Therefore, by using the intermediate data D2, the PC 1 is able to omit part of or all of the processes of selecting the second entry 2E. Thus, the PC 1 generates the preview image ImgP, which is to be displayed to the USER by the display unit 1F6, based on the intermediate data D2, and therefore the PC 1 can reduce the processing load of the process of generating the second image displayed as the preview image ImgP.

Note that the overall process according to an embodiment of the present invention can be performed by an image processing system including one or more image processing apparatuses. Specifically, the image processing system may connect to one or more other image processing apparatuses via the network, and perform all of or part of various processes in a distributed manner, in a parallel manner, or in a redundant manner.

Note that all of or part of the overall process according to an embodiment of the present invention may be realized by programs to be executed by a computer, which are described in a legacy programming language or an object-oriented programming language, such as assembler, C, C++, C#, Java (registered trademark), etc. That is, the program is a computer program for causing a computer, such as an image processing apparatus, an information processing apparatus, an image processing system, etc., to execute various processes.

Furthermore, the program may be distributed by being stored in a computer-readable recording medium such as a ROM, an EEPROM (Electrically Erasable Programmable ROM), etc. Furthermore, the recording medium may be an EPROM (Erasable Programmable ROM), a flash memory, a flexible disk, a CD-ROM, a CD-RW, a DVD-ROM, a DVD-RAM, a DVD-RW, a Blu-ray disc, a SD (registered trademark) card, an MO, etc. Furthermore, the program may be distributed through an electrical communication line.

Furthermore, the image processing system may include two or more information processing apparatuses that are connected to each other via the network, and the plurality of information processing apparatuses may perform all of or part of various processes in a distributed manner, in a parallel manner, or in a redundant manner.

According to one embodiment of the present invention, an image processing apparatus, an image processing system, and an image processing method are provided, which are capable of reducing the processing load relevant to a super-resolution process.

The image processing apparatus, the image processing system, and the image processing method are not limited to the specific embodiments described herein, and variations and modifications may be made without departing from the spirit and scope of the present invention.

The present application is based on and claims the benefit of priority of Japanese Priority Patent Application No. 2015-031239, filed on Feb. 20, 2015, the entire contents of which are hereby incorporated herein by reference.

What is claimed is:

1. An image processing apparatus for performing image processing on a first image, the image processing apparatus comprising:
a first storage unit configured to store a first entry indicating an image before changing and the image after changing;
a selecting unit configured to select a second entry from the first entry, based on a feature amount vector indicating a feature amount by a vector, the feature amount indicating a distribution of pixel values indicated by pixels included in the first image;
a second storage unit configured to store intermediate data identifying the second entry; and
a generating unit configured to generate a second image by performing the image processing on the first image, based on the intermediate data.

2. The image processing apparatus according to claim 1, wherein
the image processing by the generating unit is a process performed according to a vector based on a first vector and a second vector,
the first vector being generated by combining a first basic vector, which is defined by a second entry, and a first weight coefficient,
the second vector being generated by combining a second basic vector, which is defined by a second entry different from the second entry defining the first basic vector, and a second weight coefficient, and
the second vector being generated based on a residual vector, which indicates the difference between the feature amount vector and the first vector.

3. The image processing apparatus according to claim 2, wherein
the intermediate data includes the first weight coefficient and the second weight coefficient.

4. The image processing apparatus according to claim 3, wherein
when the selecting unit selects the second entry, the first weight coefficient and the second weight coefficient are updated in or added to the intermediate data

5. The image processing apparatus according to claim 1, wherein
the image processing by the generating unit is a process based on a vector obtained by combining a third vector and a fourth vector,
the third vector being generated by combining a first similar vector, which is defined by a second entry similar to the feature amount vector, and a third weight coefficient, and
the fourth vector being generated by combining a second similar vector, which is defined by a second entry different from the second entry defining the first similar vector, and a fourth weight coefficient.

6. The image processing apparatus according to claim 5, wherein
the intermediate data includes the third weight coefficient and the fourth weight coefficient.

7. The image processing apparatus according to claim 6, wherein
when the selecting unit selects the second entry, the third weight coefficient and the fourth weight coefficient are updated in or added to the intermediate data

8. The image processing apparatus according to claim 1, wherein
the generating unit performs the image processing based on the second entry based on the intermediate data and a second entry selected from the first entry by the selecting unit other than the second entry based on the intermediate data.

9. The image processing apparatus according to claim 1, wherein
the generating unit performs the image processing based on the second entry based on the intermediate data.

10. The image processing apparatus according to claim 1, further comprising:
a display unit configured to display a plurality of the second images.

11. The image processing apparatus according to claim 1, further comprising:
a conversion unit configured to generate the first image by changing a resolution of an input image, which is input to the image processing apparatus, to a predetermined resolution.

12. An image processing system including one or more image processing apparatuses for performing image processing on a first image, the image processing system comprising:
a first storage unit configured to store a first entry indicating an image before changing and the image after changing;
a selecting unit configured to select a second entry from the first entry, based on a feature amount vector indicating a feature amount by a vector, the feature amount indicating a distribution of pixel values indicated by pixels included in the first image;
a second storage unit configured to store intermediate data identifying the second entry; and
a generating unit configured to generate a second image by performing the image processing on the first image, based on the intermediate data.

13. An image processing method executed by an image processing apparatus for performing image processing on a first image, the image processing method comprising:
storing a first entry indicating an image before changing and the image after changing;
selecting a second entry from the first entry, based on a feature amount vector indicating a feature amount by a vector, the feature amount indicating a distribution of pixel values indicated by pixels included in the first image;
storing intermediate data identifying the second entry; and
generating a second image by performing the image processing on the first image, based on the intermediate data.
